(19) United States
(12) Patent Application Publication
(10) Pub. No.: US 2025/0053776 A1
(43) Pub. Date: Feb. 13, 2025

(54) MACHINE LEARNING APPROACH FOR GENERATION OF EXPLAINABLE NEW ENTITIES IN A KNOWLEDGE GRAPH FOR OPTIMIZATION OR IMPROVEMENT OF TARGET PROPERTIES

(71) Applicant: NEC Laboratories Europe GmbH, Heidelberg (DE)

(72) Inventors: Zhao Xu, Heidelberg (DE); Timo Sztyler, Heidelberg (DE); Carolin Lawrence, Heidelberg (DE)

(21) Appl. No.: 18/489,024

(22) Filed: Oct. 18, 2023

Related U.S. Application Data
(60) Provisional application No. 63/532,091, filed on Aug. 11, 2023.

(51) Int. Cl. G06N 3/042; G06N 3/08

(52) U.S. Cl. CPC G06N 3/042; G06N 3/08

(57) ABSTRACT

A computer-implemented, machine learning method for incorporating a new entity in a knowledge graph for optimizing or improving a target property includes detecting counterfactual causes in a causality graph that are to be modified to achieve the target property. The causality graph is connected to the knowledge graph by links representing semantic relations. The new entity is generated in the knowledge graph by embedding the new entity in a latent space of the knowledge graph relative to existing entities. A change of causes in the causality graph resulting from generating the new entity in the knowledge graph is simulated. The method can be applied, for example, to use cases in medical/healthcare, smart cities or smart agriculture, for example, to support decision making using Artificial Intelligence (AI).

### CROSS REFERENCE TO RELATED APPLICATIONS

Priority is claimed to U.S. Provisional Application No. 63/532,091, filed on Aug. 11, 2023, the entire contents of which is hereby incorporated by reference herein.

### FIELD

The present invention relates to Artificial Intelligence (AI) and machine learning, and in particular to a method, system, computer-readable medium and computer program product for generating new entities in a knowledge graph in an explainable manner.

### BACKGROUND

A knowledge graph can represent the complex relationships between entities in the world. However, existing technology employing knowledge graph approaches are limited to link prediction and entity embedding, and do not provide for entity generation, which is to add new entities (nodes) in a graph.

### SUMMARY

In an embodiment, the present invention provides a computer-implemented method for incorporating a new entity in a knowledge graph for improving a target property. The method includes detecting counterfactual causes in a causality graph that are to be modified to achieve the target property, wherein the causality graph is connected to the knowledge graph by links representing semantic relations. The new entity is generated in the knowledge graph by embedding the new entity in a latent space of the knowledge graph relative to existing entities. A change of causes in the causality graph resulting from generating the new entity in the knowledge graph is simulated. The method can be applied, for example, to use cases in medical AI or smart cities.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates a method and system according to an embodiment of the present invention for a training procedure;

FIG. 2 schematically illustrates a method and system according to an embodiment of the present invention for a prediction procedure;

FIG. 3 schematically illustrates a graph constructor component and procedure for constructing a graph according to an embodiment of the present invention;

FIG. 4 schematically illustrates an entity generator component and procedure for generating new entities according to an embodiment of the present invention;

FIG. 5 schematically illustrates a counterfactual cause detector component and procedure for detecting counterfactual causes according to an embodiment of the present invention;

FIG. 6 schematically illustrates an explainer component and procedure for explaining new entity generation according to an embodiment of the present invention;

FIG. 7 schematically illustrates a method and system according to an embodiment of the present invention applied to a use case in smart agriculture; and

FIG. 8 is a block diagram of an exemplary processing system, which can be configured to perform any and all operations disclosed herein.

### DETAILED DESCRIPTION

Embodiments of the present invention provide a method, system, computer-readable medium and computer program product that can add new entities to a knowledge graph and based thereon predict next actions and simulate and explain what these actions would cause. This can be especially advantageous for causal analysis, for example in the city planning domain.

The capacity of generative machine learning methods has been proven by the success of generative large language models (LLMs), such as ChatGPT. However, existing technology employing knowledge graph approaches are limited to link prediction and entity embedding, and do not provide for entity generation, which is to add new entities (nodes) in a graph to meet a request. Enhancing computer functionality to handle this task not only provides for improvements to the machine learning technology generally, but also can provide a number of improvements for many applications. For example, with a city planning support system, decision makers might like to know: “Which newly built entity (school or shopping mall) in which district of the city can increase inhabitation intention of citizens by how much and why?”. The commonly used link prediction methods are not able to work in solving the entity generation problem, as they can only predict unknown links among existing nodes and can do nothing if there was no such node in the graph. Moreover, there is the technical challenge of providing for transparency for usage of AI techniques, for example according to existing or future regulatory schemes.

Embodiments of the present invention provide to solve these technical challenges and improve computer functionality by providing an explainable approach to generate new entities (including types and features) and to improve target properties. Thus, in addition to enhancing the computer functionality to perform functions that existing technology cannot perform, including the generation of new entities, embodiments of the present invention also overcome the technical challenge of providing for transparency, as the explainable approach provides that the generation of the new entities are explainable for end users. The approach according to embodiments of the present invention can quantitatively generate unknown nodes in a graph, simulate the results of the generated new nodes, and explain the causes that lead to the consequence.

According to a first aspect, the present disclosure provides a computer-implemented method for incorporating a new entity in a knowledge graph for improving a target property. The method includes detecting counterfactual causes in a causality graph that are to be modified to achieve the target property, wherein the causality graph is connected to the knowledge graph by links representing semantic relations. The new entity is generated in the knowledge graph by embedding the new entity in a latent space of the knowledge graph relative to existing entities. A change of causes in the causality graph resulting from generating the new entity in the knowledge graph is simulated.

According to a second aspect, the method according to the first aspect further comprises embedding latent vectors corresponding to each of the existing entities and relations between the existing entities in the latent space, wherein generating the new entity in the knowledge graph comprises using a neural network that includes an embedding layer that uses the embedded latent vectors of the existing entities and features of the new entity as input.

According to a third aspect, the method according to the first or the second aspect further comprises detecting counterfactual causes using an objective function that determines a minimal change in one or more of a plurality of direct causes to achieve the target property, and wherein the objective function includes as input the direct causes, a desired change in the target property and embedded latent vectors of existing entities.

According to a fourth aspect, the method according to any of the first to the third aspects further comprises simulating the change of causes in the causality graph using a simulator that receives as input an aggregation of an embedded latent vector of the new entity and embedded latent vectors of existing entities of a same type, and outputs a predicted new value for one of the causes.

According to a fifth aspect, the method according to any of the first to the fourth aspects further comprises recommending to add the new entity to a real-world implementation of a situation modeled by the knowledge graph based on a determination that the predicted new value for one of the causes is greater than or equal to the minimal change in the one or more of the direct causes that corresponds to the one of the causes.

According to a sixth aspect, the method according to any of the first to the fifth aspects further comprises determining an adaptation of the causes due to the new entity through learning functional relationships between the entities of the knowledge graph and the causes of the causality graph.

According to a seventh aspect, the method according to any of the first to the sixth aspects further comprises creating the knowledge graph by processing raw data that is collected using a sensor network that includes physical sensor readings, social media networks, databases, survey data and/or sensor stations into triples that connect entities in the knowledge graph.

According to an eighth aspect, the method according to any of the first to the seventh aspects further comprises learning an influence of existing links of the knowledge graph based on the triples.

According to a ninth aspect, the method according to any of the first to the eighth aspects further comprises providing an explanation for the generation of the new entity by identifying links of the knowledge graph that remarkably influence the predictions of the features and relations of the new entity.

According to a tenth aspect, the method according to any of the first to the ninth aspects wherein a graph-based counterfactual cause detector predicts the change of causes based on the causality graph such that the target property is changed to a target value, and wherein the predictions of the causes are changed minimally in terms of costs/effort.

According to an eleventh fourth aspect, the method according to any of the first to the tenth aspects further comprises the knowledge graph being for a smart city, the new entity being an entity to be added to a geographic location in the smart city and the target property being to improve represent an interest of citizens of the smart city.

According to a twelfth aspect, the method according to any of the first to the eleventh aspects further comprises the knowledge graph being for a molecular system or for medical treatments, the new entity being a change in molecular structure or treatment and the target property being to improve a condition of a patient.

According to a thirteenth aspect, the method according to any of the first to the twelfth aspects further comprises the knowledge graph being for status of an agricultural crop and the causality graph being for crop stresses, the new entity being an action to be taken on the crop and the target property to improve is a condition of the crops.

A fourteenth aspect of the present disclosure provides a computer system programmed for incorporating a new entity in a knowledge graph for improving a target property, the computer system comprising one or more hardware processors which, alone or in combination, are configured to provide for execution of the following steps: detecting counterfactual causes in a causality graph that are to be modified to achieve the target property, wherein the causality graph is connected to the knowledge graph by links representing semantic relations; generating the new entity in the knowledge graph by embedding the new entity in a latent space of the knowledge graph relative to existing entities; and simulating a change of causes in the causality graph resulting from generating the new entity in the knowledge graph; or a method according to any of the first to thirteenth aspects.

A fifteenth aspect of the present disclosure provides a tangible, non-transitory computer-readable medium for incorporating a new entity in a knowledge graph for improving a target property, the computer-readable medium having instructions thereon, which, upon being executed by one or more processors, provides for execution of the following steps: detecting counterfactual causes in a causality graph that are to be modified to achieve the target property, wherein the causality graph is connected to the knowledge graph by links representing semantic relations; generating the new entity in the knowledge graph by embedding the new entity in a latent space of the knowledge graph relative to existing entities; and simulating a change of causes in the causality graph resulting from generating the new entity in the knowledge graph; or a method according to any of the first to thirteenth aspects.

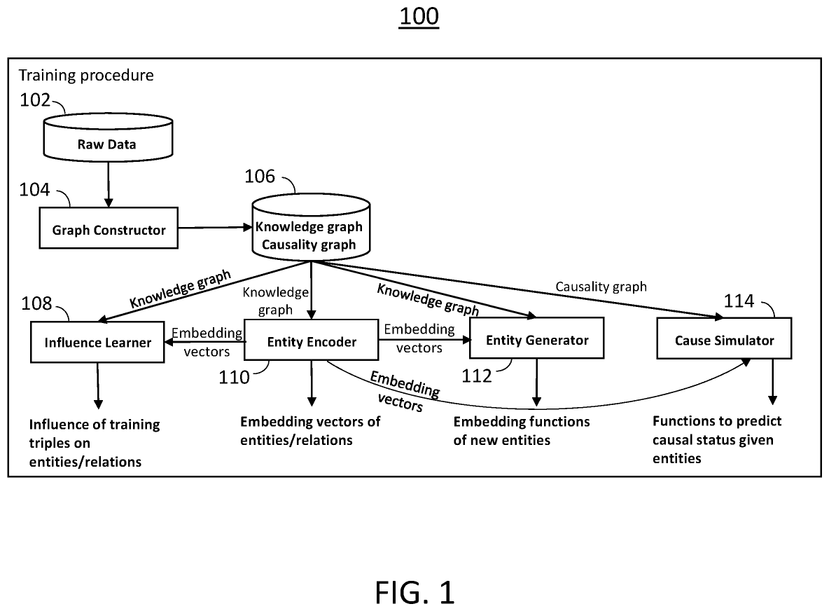

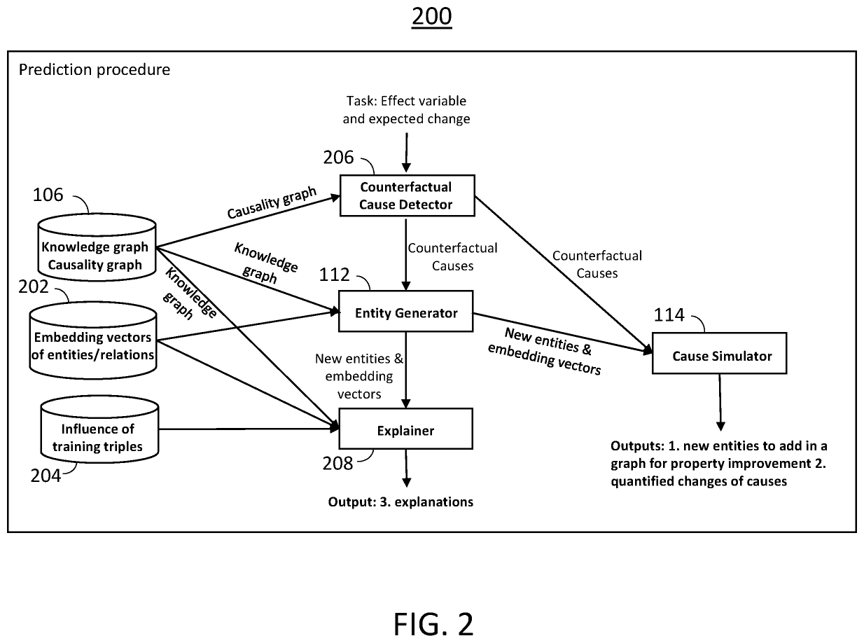

FIGS. 1 and 2 show an overall system architecture for training and prediction procedures, respectively, according to embodiments of the present invention. A running example is used herein to demonstrate the operation and improved functionality and performance of embodiments of the present invention. The running example is: “given data of cities, the decision maker expects to increase inhabitation intention of citizens from y_old to y_new, the system is to predict which new entity (e.g., school or bus station) should be generated in which district of the city to meet the expectation and why.”

FIG. 1 shows a training procedure 100. The training procedure includes raw data 102. Data in raw data 102 can be used for training a model. For example, in the given running example, the raw data 102 can be collected using a sensor network, consisting of social media networks, various databases (e.g., of the city), survey data (e.g., collected through mobile devices), and various sensor stations such as cameras or temperature sensors installed in various parts of the city. The sensor network can collect feedback from the population but also to measure the mood within certain areas. The raw data 102 that is collected through the sensor network is stored in a database. These vital, physical, and meta-parameters, collected through the sensor network, are transformed into triples. In some embodiments, the transformation of collected data into triples can be realized through trained machine learning models or simple patterns and rules. For example, a simple pattern can be used to transform collected street location information in a database into triples. In case of a street named “street A”, the stored triple can look like (“Street A,” is-located-in, “District D.)”.

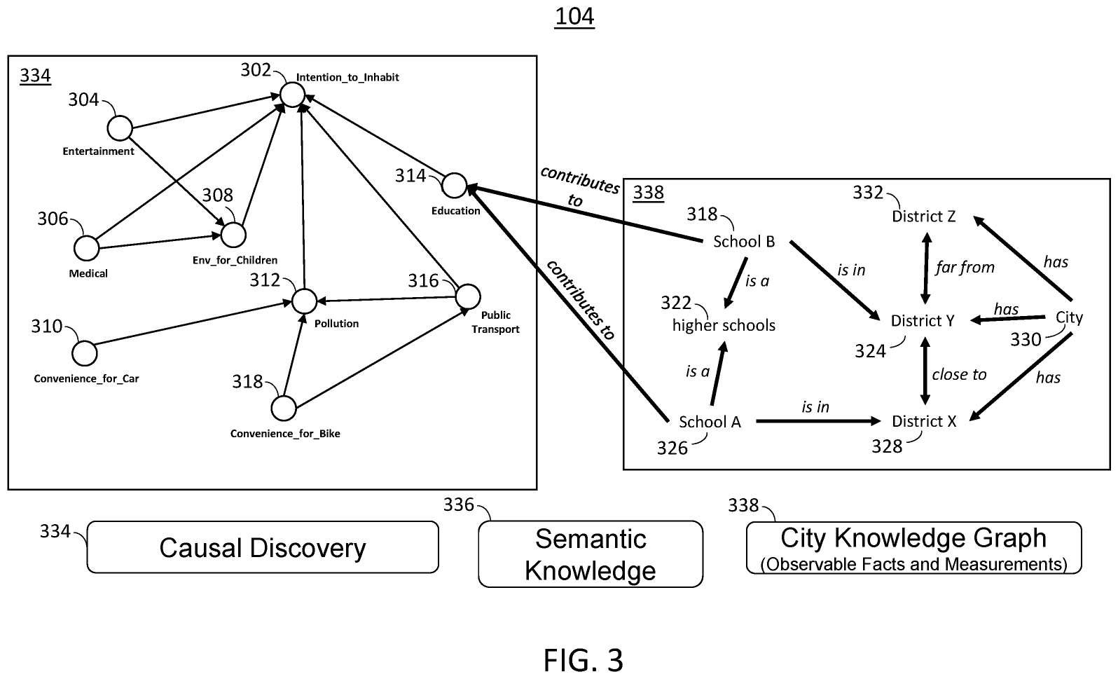

The raw data 102 is provided to a graph constructor 104. The graph constructor 104 creates a causal knowledge graph 106 based on the raw data 102. The causal knowledge graph 106 is stored in the database. In some embodiments, the creation of the causal knowledge graph 106 includes creation of a knowledge graph and a causality graph that are stored in the database and the causal knowledge graph 106 is composed of the knowledge graph and the causality graph. The creation of the causal knowledge graph 106 is explained in more details with respect to FIG. 3. The knowledge graph from the causal knowledge graph 106 is provided to influence learner 108, entity encoder 110 and entity generator 112. The causality graph from causal knowledge graph 106 is provided to cause simulator 114. The influence learner 108 determines an influence of training triples on entities and relations. The entity encoder 110 embeds vectors for entities or relations in a latent space. These embedding vectors are provided by the entity encoder 110 to the influence learner 108, the entity generator 112 and the cause simulator 114. The entity generator embeds functions of new entities in a latent space, and cause simulator 114 predicts causal status of a given latent space. Each of the elements of the training procedure 100 are discussed in more detail below.

In accordance with the running example, the causal knowledge graph 106 can be of a city. The causal knowledge graph 106 of the city can include a knowledge graph of the city and a causality graph of the city. The knowledge graph of the city includes: a set of existing entities of the city (e.g., schools and districts), features of entities, and relations among entities and features, which are represented as triples, e.g. (School_B, is_a, higher_schools) and (School_B, is_in, District Y). Embodiments of the present invention predict which new entities to build in the knowledge graph of the city.

A causality graph of the city includes: a set of interests of citizens (e.g., education, convenient public transportation, medical, environment for children, etc.) and probabilistic relations between the interests, which can be learned with probabilistic graphic models, e.g., Bayesian networks. In some embodiments, the causality graph of the city is generated from data stored in a database associated with the city that is maintained by the city (e.g., in government databases). Nodes and links are stored in tables of the city information database. Semantic knowledge provides for links between citizen interests and city knowledge graph. For example, semantic knowledge provides information that schools contribute to the interest education, and hospitals contribute to the interest medical. In some embodiments, the semantic knowledge can be collected from citizens by the city and stored in the database. The links between different types of graphs can be created from metadata information, for example, a pre-defined ontology which specifies which types of entities are related to which types of interests.

The entity encoder 110 embeds entities and relations in a latent space. It produces an embedding vector for each entity (node) and relation (edge) of a knowledge graph. This encoder can be flexible. For example, the encoder can implement a neural knowledge graph embedding method, such as DistMult (see Bishan Yang, Wen-tau Yih, Xiaodong He, Jianfeng Gao, and Li Deng, “Embedding Entities and Relations for Learning and Inference in Knowledge Bases,” arXiv: 1412.6575 (2015), which is hereby incorporated by reference herein, or KBlrn (see Alberto Garcia-Duran and Mathias Niepert, “KBLRN: End-to-End Learning of Knowledge Base Representations with Latent, Relational, and Numerical Features,” arXiv: 1709.04676 (2018), which is hereby incorporated by reference herein). In accordance with the running example, the entity encoder 110 embeds entities related to the city in the latent space. For example, the entity encoder 110 produces an embedding vector for each entity and relation of the knowledge graph that is provided from database 106. The entity encoder 110 provides the produced embedding vectors to influence learner 108, entity generator 112, and cause simulator 114.

The influence learner 108 is configured to connect the training data with predictions. In some embodiments, a new generated entity has connections with existing entities, for example, a new school will be located in the district Z, by which the predicted new entity connected back to the triples of existing district Z and schools. In some embodiments, the influence learner 108 can be an XAI (explainable AI) Module. The connection illustrates an explanation (e.g., it puts the training data and prediction into context and reveals the reasoning process of the AI model in a human understandable manner). According to embodiments of the present invention, the XAI module is provided with an “influence learner”. The influence learner 108 is configured to learn influence of existing links of the knowledge graph. In some embodiments, learning the influence of existing links involves computing the gradients of each existing triple as its influence on the entities involved in the triples. In the training procedure, the influence of each link on its involved entities is computed. In accordance with the running example, for a training triple <School B, is_in, District_Y>, the learner produces the influence of the triple on the entities School_B and District_Y. In some embodiments, gradients of the likelihood of the training triple <School B, is_in, District_Y> with respect to the embedding vectors of the involved entities School B and District_Y are computed. For example, a first gradient can be computed that calculates the influence of the triple on the entity School B, and a second gradient can be computed that calculates the influence of the triple on the entity District_Y. Intuitively, the influence quantifies how important the triple for School_B is for District_Y and vice versa. The larger the computed gradient, the more influential the training triple is on the involved entity. Gradient rollback provides a manner to compute and aggregate the gradient across training iterations. For example, according to an embodiment of the present invention, gradient rollback is employed as the influence learner 108 (see Carolin Lawrence, Timo Sztyler, and Mathias Niepert, “Explaining Neural Matrix Factorization with Gradient Rollback,” Vol. 35, No. 6: AAAI-21 Technical Tracks 6 (2021), which is hereby incorporated by reference herein), but other methods with influence as outputs can be used as well. The influence is saved in the database and, in the prediction procedure, is used by the explainer component to explain the generation of a new entity.

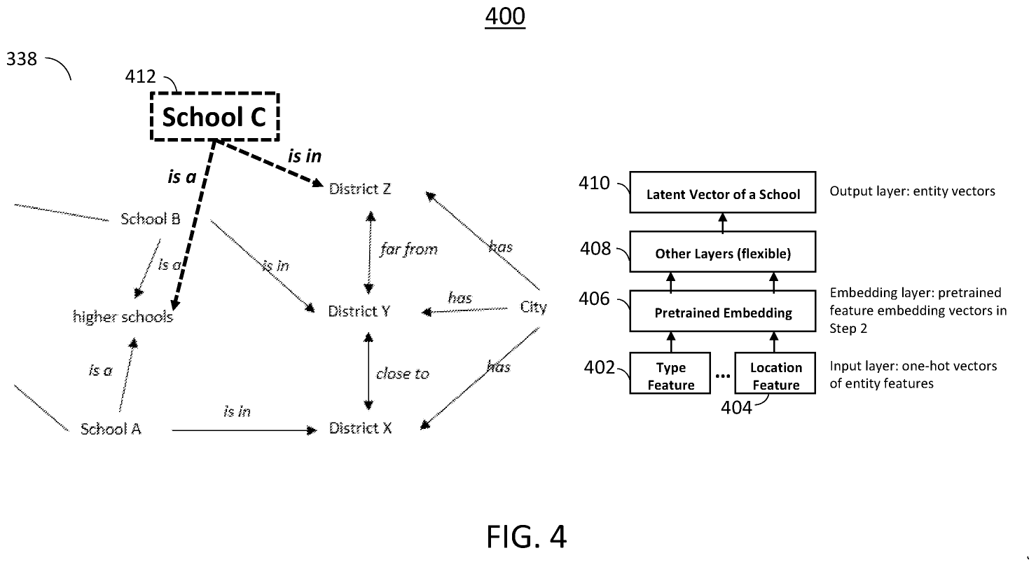

The entity generator 112 is used to generate a new entity (node) for an existing knowledge graph of causal knowledge graph 106. Generating a new entity in a graph cannot be fulfilled by the link prediction techniques of existing technology, which is limited to predict unknown links between existing entities only. In some embodiments, the entity generator samples a plurality of entities that are scored. A subset of the generated entities, for example, top-K entities, where K can be 1, 2, 3, and so on, are selected as recommendations based on the scoring. The scoring of the entities is performed by other entities depicted in FIG. 1. In some other embodiments a user can also manually input a new entity to be generated. The entity generator can generate the manually input entity and other elements depicted FIG. 1 can help simulate the effect of the new entity on the rest of the existing entities in the city. In the entity generation task, the new school C does not exist in the city, which is a predicted entity to be built in the city. In some embodiments, the new School C can be one of the entities that is scored in the top-K and can be provided as a recommendation. Since the entity, school C, does not exist in the city's knowledge graph, the link prediction methods according to existing technology do not apply and cannot be used to predict links with respect to the entity, school C, that does not exist in the graph already. For the task of new entity generation, the main technical challenge is how to embed the new entities in the same latent space as the existing entities and keep semantic consistency with them. For instance, in accordance with the running example, a task could be embedding a newly generated school C that is a higher school and located in district Z that is far from district Y of an existing school B. To this end, the entity generator according to an embodiment of the present invention learns a function g: {0,1}^{M}→R^{K} that maps an entity with features x∈{0,1}^{M} to the latent vector z∈R^{K}. Features are the triples of the entity. A neural network with x as input and z as output is used to represent and learn the function. In some embodiments, the entity generator implements a neural network. Generally, neural networks are functions that can approximate any functions. The system 100 depicted in FIG. 1 can sample a set of triples generated for the new entity and simulate the effect of the new entity on the existing entities. For semantic consistency with existing entities, an embedding layer is provided that includes the embedding vectors of all possible features, such as district X and higher schools (e.g., the outputs of the entity encoder component). The other layers of the neural network can be flexible. During the training procedure, the latent vectors and features of existing entities serve as the training data to learn the neural network. The entity generator is explained in more detail in FIG. 4.

In some embodiments, the neural network of the entity generator is trained to predict the embedding vectors of the sampled new entities. In the training phase, the neural network is trained with triples of existing entities and their embedding vectors. The neural network takes the triples of the existing entities as inputs and outputs embedding vectors of the existing entities. Once the neural network is trained, the neural network, in the prediction phase, takes the triples of the new entities as input and provides predictions of the embedding vectors of the new entities as outputs.

The neural network of the entity generator is to compute embedding vectors of new entities. The inputs are the sampled triples of the new entities, the outputs are the embedding vectors of the new entities.

Cause simulator 114 learns functional relationships between the entities of the knowledge graph and the causes of the causality graph of the causal knowledge graph 106. It executes what-if predictions such as “what is the change of the causes if the predicted new entity is added in the knowledge graph.” In accordance with the running example, it can predict what the cause C₁ [symbol] good_education will be if the city executes the decision of building a new higher school C in district Z. In particular, the simulator learns a function ƒ: R^{K}→R that maps the entity latent vectors Z∈R^{K} to a scale (value of the cause C₁). In some embodiments, in accordance with the running example, the cause simulator computes an improvement provided by adding a new school to a district. The improvement can be provided to the “cause of good education.” The computed improvement can be compared with a target improvement received from the counterfactual cause detector. For example, the counter factual cause detector can provide that the cause good education is to be improved from 0.5 to 0.7. The cause simulator 114 can simulate the effect of generating the new school on the cause good education. A neural network with the embedding vectors Z of the entities as input and the cause value C₁ as output is used to represent and learn the function ƒ. Embedding vectors Z also include embedding vectors of the new entity generated by entity generator 112. In some embodiments, the cause values can be collected from the city information database stored at city hall. The neural network of cause simulator 114 is to compute the cause values of new entities are added into the city graph. The inputs are embedding vectors and new entities and existing entities that are linked to the cause. The outputs are a cause value. Since a city may have included multiple higher schools, a sum vector can be used as the input. In the training procedure, the function ƒ is trained with the existing city data. In the prediction procedure, the sum of the newly generated school and the existing schools will be the updated input, and the cause simulator will predict the new value of the cause. Because the schools are connected to cause C1 of good education, the prediction of the neural network of the cause simulator 114 is a new value of C1 after the newly generated school is added to the graph. If the change of C₁ is larger than or comparable to the detected counterfactual causes (the output Δc₁ of the last step of the cause detector component), then the predicted new entity is provided to the policy maker as a solution/action to improve the target property.

FIG. 2 shows a prediction procedure 200. The prediction procedure 200 predicts a change in effect caused by new entities that maybe added in a causal knowledge graph 106. In some embodiments, the prediction procedure 200 is able to determine which new entities may need to be added to the causal knowledge graph 106 to achieve a target property. The prediction procedure 200 can make this determination, by determining a quantified change in the target property when different nodes are added in the knowledge graph. Finally, the prediction procedure 200 is also able to provide explanations as to why adding a particular new node effects a target property. This provides much needed transparency in the usage of AI techniques. The prediction procedure 200 utilizes a counterfactual cause detector 206, the entity generator 110, explainer 208, and cause simulator 114.

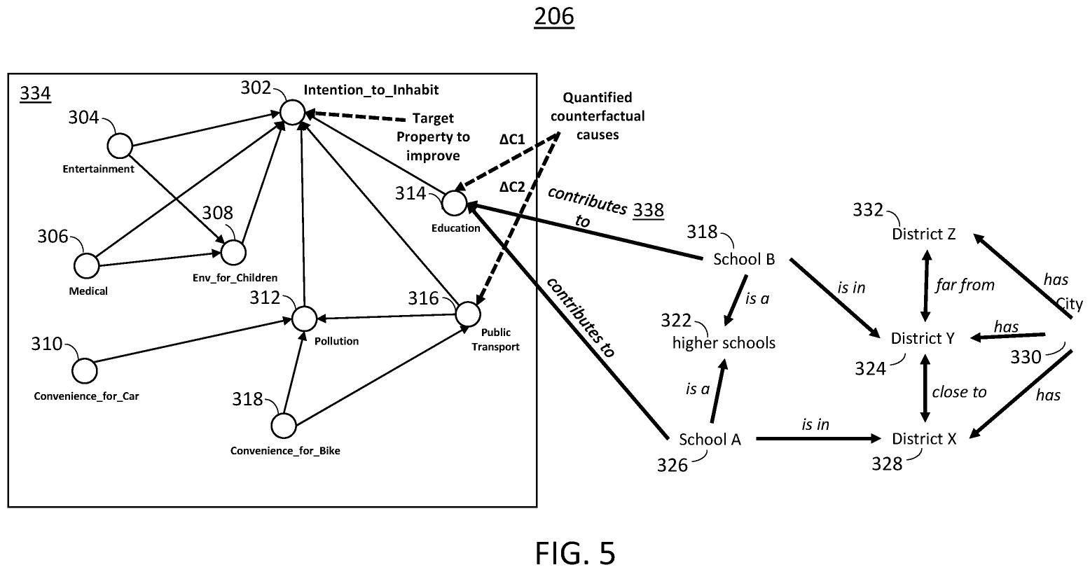

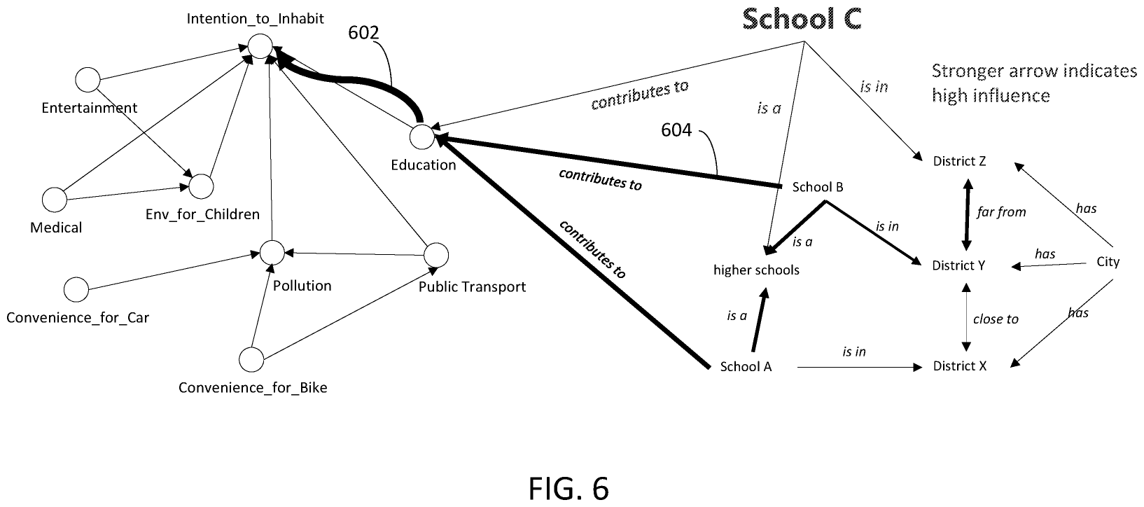

In the prediction procedure 200, the causality graph from the causal knowledge graph 106 is provided to counterfactual cause detector 206. The counterfactual cause detector is explained in more detail in FIG. 5. The knowledge graphs from the causal knowledge graph 106 are provided to the entity generator 110 and explainer 208. The explainer 208 is explained in more detail in FIG. 6. The output 202 of the entity encoder 110, which is the embedding vectors for each entity (node) and relation (edge) of a knowledge graph of the causal knowledge graph 106 is provided to the entity generator 112 and the explainer 208. The output 204 of the influencer 108 is provided to the explainer 208. The output from the counterfactual cause detector 206, the counterfactual causes are provided to the entity generator 112 and the cause simulator 114. New entities and embedding vectors associated with the new entities that are generated by the entity generator 112 are provided to the cause simulator 114. The prediction procedure 200 produces three main outputs. The cause simulator 114 determines new entities to be added in the knowledge graph to achieve a target property and the numeral changes to the target property as a result of the addition of the new node. The explainer 208 of the prediction procedure 200 provides an explanation as to why the change in the target property takes place.

The counterfactual cause detector 206 aims to learn how to change the causes based on the causality graph such that a targeted effect variable is changed to the given target property. The counterfactual cause detector 206 provides a counterfactual explanation of a prediction. The counterfactual explanation of the prediction describes the smallest change to the feature values that changes the prediction to a predefined output. In accordance with the running example, if the decision makers of a city plan to increase intention_to_inhabit of the city from the current value (y_{old}=3.5) to a higher one (y_{new}=4.2), it is learned how to minimally change the direct causes:

C₁ [symbol] good_education, or

C₂ [symbol] convenient_public_transportation?

The causes discussed in the disclosure are for exemplary purposes only. In some embodiments, causal analysis can be performed on other causes affecting intention to inhabit such as entertainment, environment for children, pollution, and public transport.

The counterfactual cause detector learns to identify a minimal change of either cause to meet the goal. The learning objective can be formulated as follows for optimization:

$${arg min}_{Δ {x}_{1}} max ( p ( {y}_{old} \vert {c}_{1} + Δ {c}_{1} , {c}_{2} ) - p ( {y}_{new} \vert {c}_{1} + Δ {c}_{1} , {c}_{2} ) , 0 )$$

where the conditional density function p(y|c₁, c₂) is given (e.g., the outputs of the entity encoder component). The function is represented as ƒ(c₁, c₂, y) with c₁, c₂ and y as inputs and the probability density p(y|c₁, c₂) as output. The optimization problem can then be further extended as:

$${c}_{1}^{*} = {arg}_{{C}_{1}} min max ( f ( Y = {y}_{old} \vert {C}_{1} , {C}_{2} = {c}_{2} ) - f ( Y = {y}_{new} \vert {c}_{1} , {C}_{2} = {c}_{2} ) , 0 )$$

$$Δ {c}_{1} = {c}_{1}^{*} - {c}_{1}$$

Δc1 represents the minimal change to good education cause to achieve a target of intention_to_inhabit. Equivalently, the optimal change required of the other direct causes for the intention_to_inhabit in reaching the target property can also be learned in a similar manner.

The outputs of the counterfactual cause detector, which are the counterfactual causes, are provided to cause simulator 114. In some embodiments, the counterfactual causes are a smallest change to be applied to feature values that change a prediction to a predefined output. For example, the counterfactual cause detector 114 can describe the smallest change required in the interest of education for the target intent_to_inhabit to be achieved. The cause simulator 114 also receives new entities and embedding vectors from the entity generator 112. In the prediction procedure 200, the sum of a newly generated entity and the existing entities of the causal knowledge graph 106 will be the updated input, and the cause simulator 114 will predict the new value of the cause of good education. If the calculated change of C₁ (good education) is larger than or comparable to the detected counterfactual causes (the output Δc₁ (the smallest change in the cause of good education so as to achieve a target intention_to_inhabit) of the last step of the cause detector component), then the predicted new entity is provided to the policy maker as a solution/action to improve the target property.

The explainer 208 uses the output of the influence learner 108 or the XAI module and the output of the entity generator 112 to identify the influential facts that substantially impact the prediction. Based on the value of the influence, it can be determined which existing links would be important for the generation of the new entity (see FIG. 6). The explainer 208 provides an explanation as to why a particular new entity should be selected to reach a target property.

FIG. 3 illustrates a graph constructor component and procedure for constructing a graph according to an embodiment of the present invention. The graph constructor component illustrated in FIG. 2 is a more detailed version of graph constructor 104 depicted in FIG. 1. The graph constructor 104 depicts a causal knowledge graph 106 that is composed of the knowledge graph 338 and causality graph 334. In accordance with the running example, the knowledge graph 338 includes a set of existing entities of the city, such as schools and districts, and features of the schools such as higher schools. The relation between the entities of the knowledge graph 338 are stored as triples. For example, a triple (School_B, is_a, higher schools) links the entity School B 318 to a pool of higher schools 322 in a city. Similarly, another triple (School_B, is_in, District_Y) links School B 318 to District Y 324. The knowledge graph 338 also includes information that District Y 324 is close to District X 328 but is fat from District Z 332. District X 332, District Y 324, and District Z 328 are all part of City 330. Additionally, the knowledge graph 338 also includes information that School A 326 is a higher school in District X 328. All the information related to the knowledge graph is stored in triples as described above.

The causality graph 334 of the causal knowledge graph 334 includes a set of interests of the citizens, for example, intention_to_inhabit 302, entertainment 304, medical 306, env_for_children 308, convenience_for_car 310, pollution 312, education 314, public transport 316, and convenience_for_bike 318. Probabilistic relations between the interests are determined using probabilistic graphic models, e.g., Bayesian networks. Semantic knowledge 336 is used to link the knowledge graph 338 with the causality graph 334. For example, as is seen in FIG. 3, the School A 326 and School B 318 contribute to the citizen interest of education represented by 314. Similarly, hospitals in the city may contribute to the citizen interest of medical represented by 306.

As described above, the data source for creating the knowledge graph 338 is a sensor network, consisting of social media networks, various databases (e.g., of the city), survey data (e.g., collected through mobile devices), and various sensor stations such as cameras or temperature sensors. The sensor network can collect feedback from the population but also to measure the mood within certain areas. These vital, physical, and meta parameters, collected through the sensor network, are transformed into triples. The transformation can be realized through trained machine learning models or simple patterns and rules.

FIG. 4 schematically illustrates an entity generator component and procedure for generating new entities according to an embodiment of the present invention. Process 400 of FIG. 4 is directed to inserting a new node into a knowledge graph. The entity generator may be implemented as a neural network. In keeping with the running example, the new node is of School C 412 that is inserted in the city knowledge graph 338 shown in FIG. 4. The new node School C 412 is not in existence in the city, and therefore is not already part of the knowledge graph 338 of the city. When new node of School C 412 is generated, it is input into the knowledge graph 338 using the input layer. The neural network of the entity generator takes the features of the new entity as input, and outputs entity vectors associated with the new entity. The input layer involves assigning various features to the new node of School C 412. In this example, the features of the new node are type 402 and location 404. As is shown in FIG. 4, the new node is assigned a type of high school and a location of District Z. These features are stored as triples associated with the new node 412. For example, for the new node of School C 412, the triples will be (School_C, is_in, District_Z) and (School_C, is_a, higher_schools). Using this information, the new node School C 412 is embedded in the knowledge graph using the embedding layer. The embedding layer of the neural network is a pre-trained embedding feature 406 that embeds vectors associated with the new node 406 in the knowledge graph 338. The embedding layer consists of the embedding vectors of all possible features in the knowledge graph 338. There may be other layers 408 within the neural network as well which allow the neural network to be flexible. Finally, the neural network of the entity generator outputs entity vectors of the new node School C that are provided to the explainer 208.

FIG. 5 schematically illustrates a counterfactual cause detector component and procedure for detecting counterfactual causes according to an embodiment of the present invention. The counterfactual cause detector 206 is configured to learn how to change the causes based on the causality graph such that the targeted effect variable is changed to the given goal. In keeping with the running example, the goal is to improve the intention_to_inhabit feature of the causality graph 334. As is seen in causality graph 334, citizen's interest of education 314, public transport 316, env_for_children 308 and entertainment 304 directly affect the intention_to_inhabit 302 of the city. For the purposes of this example, the counterfactual cause detector 206 compares the effect of changing features education 314 and public transport 316 on the intention_to_inhabit 302 of the city. However, one of skill in the art will understand that this technique may be extended to the other nodes entertainment 304 and env_for_children 308 as well.

In order to make the determination, the counterfactual cause detector 206 learns to identify minimal changes of either cause (education 314 or public transport 316) to meet the goal of increasing the intention_to_inhabit feature 302. Mathematically, the changes are represented as follows:

C₁ [symbol] good_education, or

C₂ [symbol] convenient_public_transportation?

The counterfactual cause detector learns to identify a minimal change of either cause to meet the goal. The learning objective can be formulated as follows for optimization:

$${arg min}_{Δ {x}_{1}} max ( p ( {y}_{old} \vert {c}_{1} + Δ {c}_{1} , {c}_{2} ) - p ( {y}_{new} \vert {c}_{1} + Δ {c}_{1} , {c}_{2} ) , 0 )$$

where the conditional density function p(y|c₁, c₂) is given in the causal graph. The function is represented as ƒ(c₁, c₂, y) with c₁, c₂ and y as inputs and the probability density p(y|c₁, c₂) as output. The optimization problem can then be further extended as:

$${c}_{1}^{*} = {arg}_{{C}_{1}} min max ( f ( Y = {y}_{old} \vert {C}_{1} , {C}_{2} = {c}_{2} ) - f ( Y = {y}_{new} \vert {c}_{1} , {C}_{2} = {c}_{2} ) , 0 )$$

$$Δ {c}_{1} = {c}_{1}^{*} - {c}_{1}$$

FIG. 6 schematically illustrates an explainer component and procedure for explaining new entity generation according to an embodiment of the present invention. The explainer 208 receives new entities and embedding vectors from entity generator 112 and identifies the influential facts that impact the prediction remarkably. As used herein, “remarkably” means that the impact is over a threshold that can be input, predetermined or learned. In some embodiments, the type of entity determines the influence of the entity on the target property. For example, it can be understood that education more strongly influences intention_to_inhabit more strongly than other causes of the causality graph. Therefore, any changes to education, for example, adding a new school, will more easily achieve the target property. The probabilistic dependencies that determine the influence of the various entities on the target cause are given in causality graph, computed with probabilistic graphic models based on data stored in the city database. Based on the value of the influence, one could recognize which existing links would be important for the generation of the new entity. In FIG. 6, the arrows 602 and 604 are in different levels of shading, and the stronger shading represents a higher influence on the target. In some embodiments, the outputs of the explainer 208 are important training triples that can largely influence the embedding vectors of the existing entities, and thus influence the predicted triples of the new entity. It can be shown to users as a list of triples, or visualized on the city knowledge graph, as shown in FIG. 6.

Embodiments of the present invention thus provide for general improvements to computers in machine learning systems not only to be able to add new entities to a graph used for a machine learning task, but also to learn influences on decisions with respect to new and existing entities that provide that the decisions are reliable, accurate, trustworthy and self-explainable. Moreover, embodiments of the present invention can be practically applied to use cases to effect further improvements in a number of technical fields including, but not limited to, medical (e.g., digital medicine, personalized healthcare, AI-assisted drug or vaccine development and smart cities (e.g., automated traffic or vehicle control, smart districts, smart buildings, smart industrial plants, smart agriculture, energy management, etc.)

In an exemplary embodiment, the present invention can be applied for causal analysis for a smart city. For example, a use case is an initiative which aims to help policy makers of a city to predict the actions (e.g., optimal entities (school, shopping mall, bus station, etc.) to build for a certain target (e.g., increase of inhabitation intention). Application of an embodiment of the present invention can provide predicted actions and causal explanations of the predicted actions, as well as simulate the quantified consequence of building the predicted entity. The data source for this use case includes a city knowledge graph that includes observable facts and measurements, as well as a causal graph that specifies the causality relations between factors that influence the satisfactory of residence. The data source for creating the knowledge graph is a sensor network, consisting of social media networks, various databases (e.g., of the city), survey data (e.g., collected through mobile devices), and various sensor stations such as cameras or temperature sensors. The sensor network can collect feedback from the population, and could also additionally measure the mood within certain areas. These vital, physical, and meta parameters, collected through the sensor network, are transformed into triples. The transformation can be realized through trained machine learning models or simple patterns and rules. Given the knowledge graph, the system according to an embodiment of the present invention suggests one or a series of entities that could be built/modified, explains why these entities were chosen and simulates what effect this would have on the city. Outputs can include: 1) a list of optimal new entities to create in the city, 2) an indication of the extent to which each new entity can improve the targeted metric, and 3) an explanation of why the new entity can improve the targeted metric. As automated actions, or technicity, a simulation or the sensor network can be controlled, or a new entity can be added in the simulation or the real world (e.g., a new control sign). Assuming that the end-user is using a mobile device or a virtual reality equipment for simulating changes, the output of the system can be used to directly guide the user how to control the sensor network, which is used as input to the system, and also will creditably assist the user to control the mobile device or the virtual reality equipment (as the simulation shows the user what actions to perform).

In an exemplary embodiment, the present invention can be applied for discovery of structurally distinguished molecules. For example, a use case can be for the development of new drugs, which is increasingly important as humans adapt to existing antibiotics. The development of new drugs goes along with so-called wet lab experiments. A wet lab is a type of laboratory in which a wide range of experiments are performed, including characterizing enzymes in biology and titration in chemistry. Wet lab experiments consume huge amounts of time and resources, both in terms of physical resources and expert time, as well as computational and machine/energy resources, and are therefore expensive and at the same time there are an enormous number of possible combinations which can be analyzed. Therefore, researchers must decide at some point whether it is worth to continue the wet lab experiments for a particular drug or to continue with the next step. In such a scenario, AI can help to discover molecules which are structurally distinct from a known antimicrobial (e.g., an antibiotic). AI can also help to identify a small subset of molecules out of millions of molecules which are potentially of interest for the development of a new drug. Application of an embodiment of the present invention enables to model or modify such complex structures (e.g., molecules) including related attributes (e.g., mass, shape, and physical properties), and to present the predictions along with an explanation or causes (e.g., structurally distinct molecular, or the relations between those). The user can modify the cause which allows to simulate how modifying the cause influences the system. This cyclic human-computer interaction process supports decision making which in turn optimizes the trade-off between cost (time, resources) and potential gain (information gain through potential wet lab experiments). Considering the outlined use case, an embodiment of the present invention provides to decide whether it is worth the resources to analyze, e.g., additional proteins. The data source for this use case includes any available protein, drug or disease information including DNA data and amino acid sequences. Given the knowledge graph, the system according to an embodiment of the present invention provides a (ranked list of) actions (new entities) for a particular situation and explains through the influence learner why these treatments were chosen and simulates what effect this would have on the patient. Outputs can include: 1) a ranked list of treatment recommendations, 2) explanations why these treatments were suggested, and 3) a simulation of what effect the treatment would cause in the patient. In some embodiments, the proteins, drugs and diseases are different nodes of a causal knowledge graph. The relations between the nodes are links between them, for example, drug A targets protein B, protein B causes disease C. The treatment is a new drug and the target is to improve the health condition of a patient.

As automated actions, or technicity, the output of the system can be provided to an expert to be used/evaluated to adjust a machine for the wet lab experiments (e.g., autoclave or spectrophotometer), or the machine can be automatically adjusted without the human in the loop.

In an exemplary embodiment, the present invention can be applied for smart agriculture to provide explainable action recommendations for agricultural development. For example, a use case can be to provide farmers with actionable recommendations and explanations to proactively solve a potential disease of their crops, which will increase the efficiency of farm work and the quality of products. In this use case, the data source includes a knowledge graph of crops status and a causal graph of crops stresses. Given the knowledge graph, the system according to an embodiment of the present invention suggests a series of actions that could be taken, explaining why these actions were chosen and simulating what effect this would have on the farm. Outputs can include: 1) a list of optimal activities to eliminate potential disease conditioned on status of crops, and 2) explanations of why the actions can solve the potential disease. As automated actions, or technicity, the output of the system can be used to control the agricultural conditions, such as amount of water (e.g., adjusting valves) or ventilation (e.g., decrease), as well as instruct smart equipment on how to treat the plants (e.g., type or amount of pesticides).

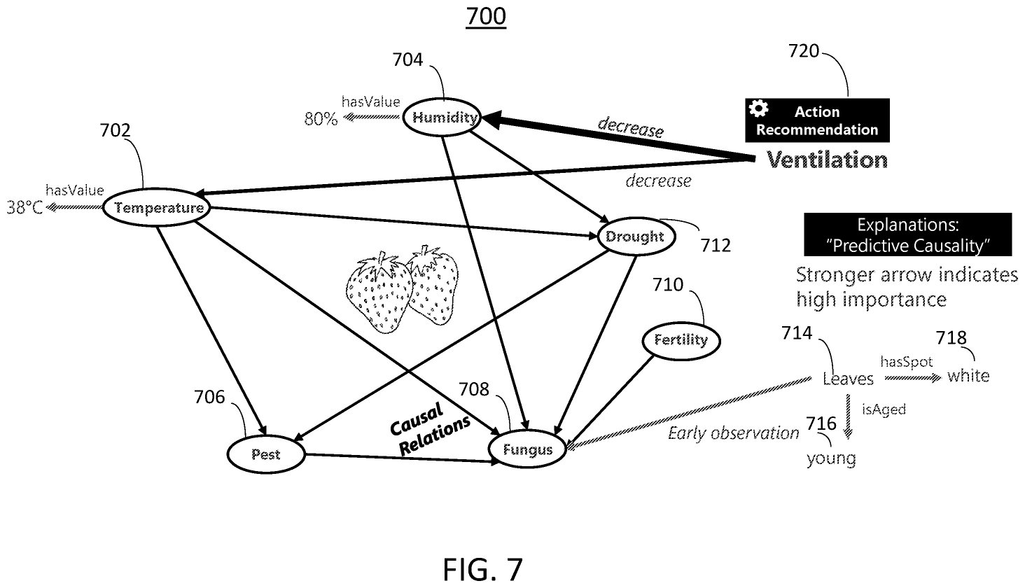

FIG. 7 schematically illustrates a method and system according to an embodiment of the present invention applied to a use case in smart agriculture. System 700 depicts a knowledge graph of crops status and a causal graph of crops stresses. For example, as shown in FIG. 7, the knowledge graph of crops status includes entity 714 leaves, an entity 718 white and an entity 716 young. The leaves may be related to entity 716 young to highlight the age of the leaf and the may be related to entity 718 white to highlight spots on the leaf.

The causal graph of system 700 includes nodes temperature 702, humidity 704, pest 706, fungus 708, fertility 710, and drought 712. These nodes represent the stresses on the crops. Given the knowledge graph, the system 700 predicts a series of actions that could be taken, explaining why these actions were chosen and simulating what effect this would have on the farm. For example, the output of the system 700 can be used to control the ventilation (e.g., decrease) but also to instruct smart equipment on how to treat the plants (e.g., number of pesticides). A list of optimal activities are shown to eliminate potential disease conditioned on status of crops, and second, explanations of why the actions can solve the potential disease. For example, the action recommended in FIG. 7 is ventilation and the explanations provided is the “predictive causality.” The stronger shading on the arrow implies a higher importance for the cause.

In an embodiment, the present invention provides a method for generating new entities in a knowledge graph to improve the target properties and to provide causes of the entity generation, the method comprising the steps of:
1) Collecting information and processing it into a causal knowledge graph (see graph constructor component).
2) Embedding entities in a latent space (see entity encoder component).
3) Learning influence of existing triples, in the case the influence will be used for an explanation (see XAI module or influence learner component).
4) Predicting new entities to be generated (see entity generator component). In some embodiments, the system can sample different entities, simulate their effects, and predict which should be selected to meet the target. Based on the causality graph, the system can identify the most important cause. The most important cause is the one in which the slightest or smallest change to the value of the cause can improve the target, e.g., intention_to_inhabit, by a significant or largest amount.
5) Detecting counterfactual causes towards the target (see counterfactual cause detector component).
6) Simulating a change of causes due to the predicted new entities (see cause simulator component). The cause simulator can include multiple simple neural networks, each of which quantities a pair (entity type, cause) or learns a single but complicated neural network that approximates quantified relations between entity types and causes.
7) Explaining the new entities, in the case that an explanation is to be provided (see explainer component).
8) Outputting new entities to add in the graph for property improvement, quantified changes of causes, and, in the case it is provided, the explanations.

Embodiments of the present invention provide for the following improvements over existing technology:

1. Enabling to determine a required, but not-yet-existing entity and to add it to the knowledge graph. In particular, providing for:
a. The creation of a single new node instance, not existing in the training data, through generative AI.
b. The embedding of the newly created node through a latent space-based mapping function (in reference to the existing knowledge graph).
   2. Providing a graph-based counterfactual cause detector which learns the relation between cause and effect. In particular, providing to predict how to change the causes based on the causality graph such that the targeted effect is changed to the given goal, whereby the causes to be changed are minimal in terms of costs/effort/resources.
   3. Enabling to estimate how the adaptation of the cause due to the newly predicted and added entities changes the actual situation. In particular, providing that:
a. The cause simulator learns the functional relationship between the entities of the knowledge graph and the causes of the causality graph.
b. Through what-if predictions, the newly added entity, and existing entities of the same type are put into context to more accurately measure the influence.

Existing link prediction methods and explainers cannot generate new entities or run a causal analysis. Thus, such existing technology is limited and cannot be used, for example, for the city planning use case. In contrast, embodiments of the present invention can be used to predict which entity needs to be added to a graph, and can also explain why and simulate what would happen if such an entity is added. Thus, embodiments of the present invention improve graph-based AI systems and XAI, and can be applied to enhance computer functionality of existing systems by offering extra functionality to predict which new entity to be generated and to explain what adding such an entity would do to an overall system described by the knowledge graph. Thus, embodiments of the present invention can be employed in numerous contexts to improve machine learning systems that already employ knowledge graphs. The enhanced functionality to provide explanations for the new entities is especially advantageous as the demand for explainable and transparent AI systems continues to grow. Application domains include city planning, healthcare, digital government, public safety, and agriculture.

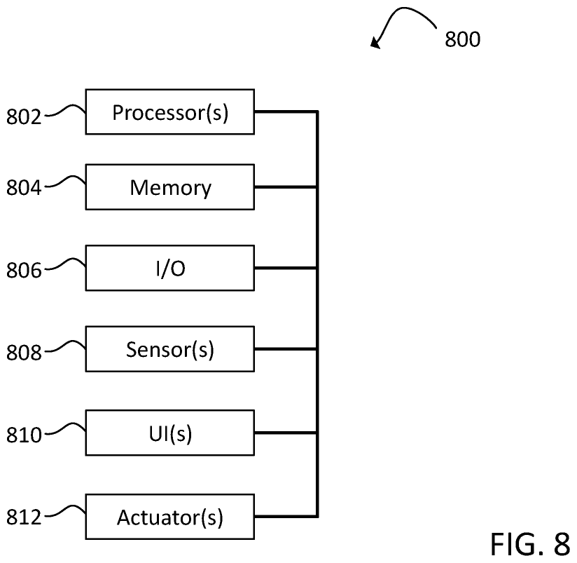

Referring to FIG. 8, a processing system 800 can include one or more processors 802, memory 804, one or more input/output devices 806, one or more sensors 808, one or more user interfaces 810, and one or more actuators 812. Processing system 800 can be representative of each computing system disclosed herein.

Processors 802 can include one or more distinct processors, each having one or more cores. Each of the distinct processors can have the same or different structure. Processors 802 can include one or more central processing units (CPUs), one or more graphics processing units (GPUs), circuitry (e.g., application specific integrated circuits (ASICs)), digital signal processors (DSPs), and the like. Processors 802 can be mounted to a common substrate or to multiple different substrates.

Processors 802 are configured to perform a certain function, method, or operation (e.g., are configured to provide for performance of a function, method, or operation) at least when one of the one or more of the distinct processors is capable of performing operations embodying the function, method, or operation. Processors 802 can perform operations embodying the function, method, or operation by, for example, executing code (e.g., interpreting scripts) stored on memory 804 and/or trafficking data through one or more ASICs. Processors 802, and thus processing system 800, can be configured to perform, automatically, any and all functions, methods, and operations disclosed herein. Therefore, processing system 800 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 800 can be configured to perform task “X”. Processing system 800 is configured to perform a function, method, or operation at least when processors 802 are configured to do the same.

Memory 804 can include volatile memory, non-volatile memory, and any other medium capable of storing data. Each of the volatile memory, non-volatile memory, and any other type of memory can include multiple different memory devices, located at multiple distinct locations and each having a different structure. Memory 804 can include remotely hosted (e.g., cloud) storage.

Examples of memory 804 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 804.

Input-output devices 806 can include any component for trafficking data such as ports, antennas (i.e., transceivers), printed conductive paths, and the like. Input-output devices 806 can enable wired communication via USB®, DisplayPort®, HDMI®, Ethernet, and the like. Input-output devices 806 can enable electronic, optical, magnetic, and holographic, communication with suitable memory 806. Input-output devices 806 can enable wireless communication via WiFi®, Bluetooth®, cellular (e.g., LTE®, CDMA®, GSM®, WiMax®, NFC®), GPS, and the like. Input-output devices 806 can include wired and/or wireless communication pathways.

Sensors 808 can capture physical measurements of environment and report the same to processors 802. User interface 810 can include displays, physical buttons, speakers, microphones, keyboards, and the like. Actuators 812 can enable processors 802 to control mechanical forces.

Processing system 800 can be distributed. For example, some components of processing system 800 can reside in a remote hosted network service (e.g., a cloud computing environment) while other components of processing system 800 can reside in a local computing system. Processing system 800 can have a modular design where certain modules include a plurality of the features/functions shown in FIG. 8. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications can be made, by those of ordinary skill in the art, within the scope of the following claims, which can include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B. or the entire list of elements A. B and C.

1. A computer-implemented, machine learning method for incorporating a new entity in a knowledge graph for optimizing or improving a target property, the method comprising:
detecting counterfactual causes in a causality graph that are to be modified to achieve the target property, wherein the causality graph is connected to the knowledge graph by links representing semantic relations;
generating the new entity in the knowledge graph by embedding the new entity in a latent space of the knowledge graph relative to existing entities; and
simulating a change of causes in the causality graph resulting from generating the new entity in the knowledge graph.

2. The method of claim 1, further comprising embedding latent vectors corresponding to each of the existing entities and relations between the existing entities in the latent space, wherein generating the new entity in the knowledge graph comprises using a neural network that includes an embedding layer that uses the embedded latent vectors of the existing entities and features of the new entity as input.

3. The method of claim 1, wherein the detecting counterfactual causes comprises using an objective function that determines a minimal change in one or more of a plurality of direct causes to achieve the target property, and wherein the objective function includes as input the direct causes, a desired change in the target property and embedded latent vectors of existing entities.

4. The method of claim 3, wherein simulating the change of causes in the causality graph is performed using a simulator that receives as input an aggregation of an embedded latent vector of the new entity and embedded latent vectors of existing entities of a same type, and outputs a predicted new value for one of the causes.

5. The method of claim 4, further comprising recommending to add the new entity to a real-world implementation of a situation modeled by the knowledge graph based on a determination that the predicted new value for one of the causes is greater than or equal to the minimal change in the one or more of the direct causes that corresponds to the one of the causes.

6. The method of claim 4, wherein the simulator determines the changes of the causes due to the new entity through learning functional relationships between the entities of the knowledge graph and causes of the causality graph.

7. The method of claim 1, wherein the knowledge graph is created by processing raw data that is collected using a sensor network that includes physical sensor readings, social media networks, databases, survey data and/or sensor stations into triples that connect entities in the knowledge graph.

8. The method of claim 7, further comprising learning an influence of existing links of the knowledge graph based on the triples.

9. The method of claim 8, further comprising providing an explanation for the generation of the new entity by identifying the links of the knowledge graph that remarkably influence the predictions of the features and relations of the new entity.

10. The method of claim 1, wherein a graph-based counterfactual cause detector predicts the change of the causes based on the causality graph such that the target property is changed to a target value, and wherein, in the predictions, the causes are changed minimally in terms of costs/effort.

11. The method of claim 1, wherein the knowledge graph is for a smart city, the new entity is an entity to be added to a geographic location in the smart city and the target property to improve represent an interest of citizens of the smart city.

12. The method of claim 1, wherein the knowledge graph is for a molecular system or for medical treatments, the new entity is a change in molecular structure or treatment and the target property to improve is a condition of a patient.

13. The method of claim 1, wherein the knowledge graph is for status of an agricultural crop and the causality graph is for crop stresses, the new entity is an action to be taken on the crop and the target property to improve is a condition of the crops.

14. A computer system programmed for incorporating a new entity in a knowledge graph for optimizing or improving a target property, the computer system comprising one or more hardware processors which, alone or in combination, are configured to provide for execution of the following steps:
detecting counterfactual causes in a causality graph that are to be modified to achieve the target property, wherein the causality graph is connected to the knowledge graph by links representing semantic relations;
generating the new entity in the knowledge graph by embedding the new entity in a latent space of the knowledge graph relative to existing entities; and
simulating a change of causes in the causality graph resulting from generating the new entity in the knowledge graph.

15. A tangible, non-transitory computer-readable medium for incorporating a new entity in a knowledge graph for optimizing or improving a target property, the computer-readable medium having instructions thereon, which, upon being executed by one or more processors, provides for execution of the following steps:
detecting counterfactual causes in a causality graph that are to be modified to achieve the target property, wherein the causality graph is connected to the knowledge graph by links representing semantic relations;
generating the new entity in the knowledge graph by embedding the new entity in a latent space of the knowledge graph relative to existing entities; and
simulating a change of causes in the causality graph resulting from generating the new entity in the knowledge graph.
